(19) United States
(12) Patent Application Publication
(10) Pub. No.: US 2026/0316935 A1
(43) Pub. Date: Oct. 15, 2026

(54) INDUCTION CHARGING HOUSING FOR A SEAT, PROVIDED WITH A TRANSVERSE RETAINING DEVICE

(71) Applicant: Safran Seats, Plaisir (FR)

(72) Inventors: Yann Cavereau, Moissy-Cramayel (FR); Oscar Ruiz, Moissy-Cramayel (FR); Arthur K. Glain, Moissy-Cramayel (FR)

(21) Appl. No.: 19/101,415

(22) PCT Filed: Jul. 26, 2023
(86) PCT No.: PCT/EP2023/070750

§ 371 Date: Feb. 5, 2025

(30) Foreign Application Priority Data
Aug. 31, 2022 (FR) FR2208695

(51) Int. Cl. B64D 11/06; H02J 50/00; H02J 50/10

(52) U.S. Cl. CPC B64D 11/0624; B64D 11/0636; H02J 50/005; H02J 50/10

(57) ABSTRACT

The invention relates to a seat unit for a transport vehicle comprising
a seat comprising a seat-base and a backrest,
an induction charging housing for a portable electronic device having a vertical orientation,
an induction charger capable of generating a magnetic field inside the induction charging housing, and
a retaining device for retaining the portable electronic device and having a transverse arm,
said retaining device being configured so that the transverse arm keeps the portable electronic device pressed against the back wall of the induction charging housing.

The present invention relates to an induction charging housing for a seat provided with a transverse retaining device. The invention finds a particularly advantageous, but not exclusive, application with seat units of “business class and “first class” type in an aircraft cabin.

In a manner known per se, such a seat unit comprises a seat and a side console provided with storage equipments along one side of the seat. In addition, a shell extends at least partly around the seat so as to delimit a space around the passenger. Such a configuration makes it possible to guarantee the privacy of the passenger.

The seat offers the passenger different comfort positions, from a “sitting” position to a “lying” position, in which the seat defines a substantially horizontal sleeping surface so that the passenger can lie down. Intermediate comfort positions are also provided, such as the “relax” position in which a seat back is strongly inclined. Generally, these intermediate positions are obtained by tilting the pivoting back about a horizontal axis and perpendicular to an extension axis of the seat. The passenger can remain on the seat during transitions between the different positions. The seat generally consists in particular of the back and a seat and is likely to include a leg rest and/or a foot rest, which may be fixed or linked to a kinematics of the seat.

Inductive charging of portable electronic appliances, typically mobile phones, is increasingly requested by airlines for business class aircraft seats. The induction charger is generally integrated in a horizontal upper face of the console forming a table on which the passenger can place personal objects, drinks, a meal tray, or any type of object that the passenger would like to have available nearby during the trip. However, such a configuration of the induction charger does not guarantee the necessary immobility of the mobile phone so as to ensure its charging. In addition, it takes up an upper space on the console that could be used more wisely and does not automatically offer a direct view of the progress of the phone's charge from the passenger seat.

The objective of the invention is to effectively remedy these drawbacks by providing a seat unit for a transport vehicle comprising a seat including a seating pan and a backrest,
an induction charging housing for a portable electronic appliance having a vertical orientation,
said induction charging housing comprising a lower face for an edge of the portable electronic appliance to bear thereon, an upper face, a right side face, a left side face, and a housing bottom,
an induction charger capable of generating a magnetic field inside the induction charging housing, and
a retaining device for the portable electronic appliance comprising a transverse arm,
said retaining device being configured so that the transverse arm keeps the portable electronic appliance pressed against the bottom of the induction charging housing.

The invention thus permits, thanks to the integration of an induction charging housing in a vertical orientation, to save space at the table surface of the console. The use of the retaining device allows to guarantee the induction charging of the portable electronic appliance when the latter has a vertical orientation. In addition, such an arrangement of the charging housing allows the passenger to permanently keep an eye on the portable electronic appliance, in particular so as to observe the evolution of the battery charge level.

According to one embodiment of the invention, the transverse arm is located at an intermediate height f the induction charging housing.

According to one embodiment of the invention, the retaining device is movable in rotation around a spring hinge having a horizontal axis.

According to one embodiment of the invention, the retaining device comprises two lateral arms extending on either side of the transverse arm, each lateral arm comprising a free end connected to the spring hinge.

According to one embodiment of the invention, the spring hinge is positioned below or at the lower face of the induction charging housing.

According to one embodiment of the invention, the retaining device is movable in translation in a direction normal to the bottom of the induction charging housing.

According to one embodiment of the invention, the retaining device comprises a transverse arm and a guiding arm capable of sliding inside a guiding cavity in the bottom of the induction charging housing.

According to one embodiment of the invention, a return spring is arranged inside the guiding cavity.

According to one embodiment of the invention, the retaining device is fixed relative to the induction charging housing and comprises a layer of deformable material fixed to a rear face of the transverse arm, said layer of deformable material being intended to be compressed in order to keep the portable electronic appliance pressed against the bottom of the induction charging housing.

According to one embodiment of the invention, the layer of deformable material is formed by a shape-memory foam layer.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

FIG. 1 is a perspective view of a seat unit comprising an induction charging according to the present invention;

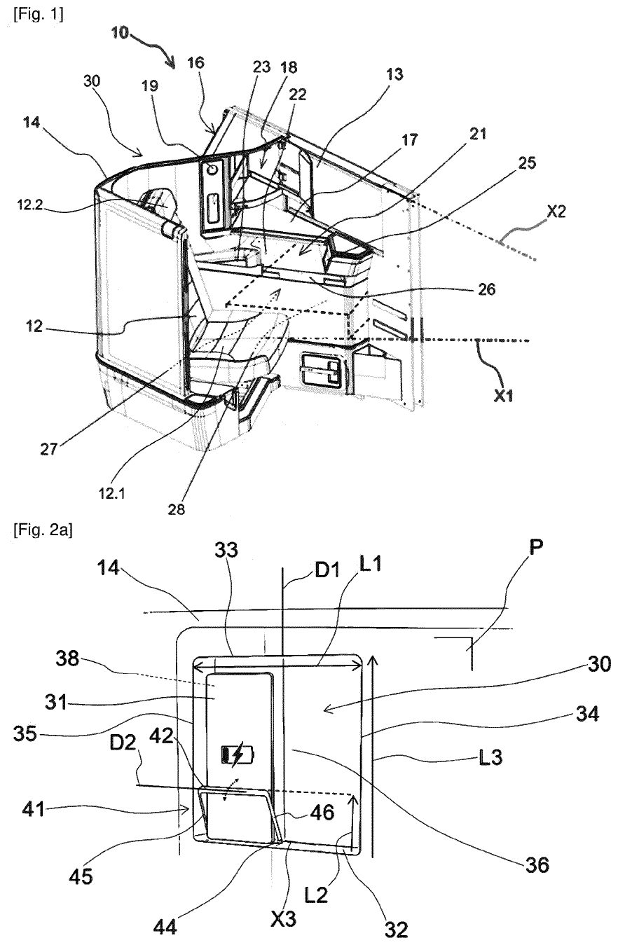

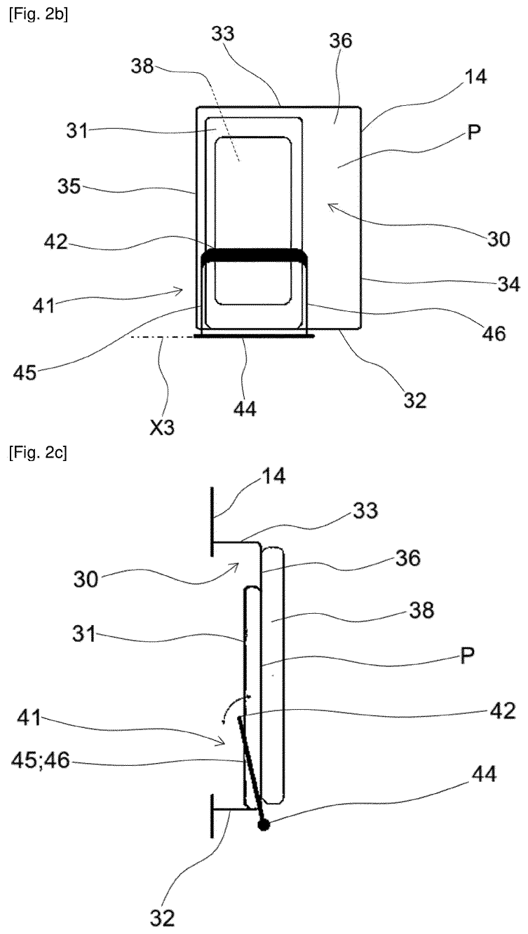

FIG. 2a FIG. 2b FIG. 2c FIGS. 2a, 2b, and 2c are respectively perspective, front, and side views of a first embodiment of a device according to the invention for retaining a portable electronic appliance inside an induction charging housing;

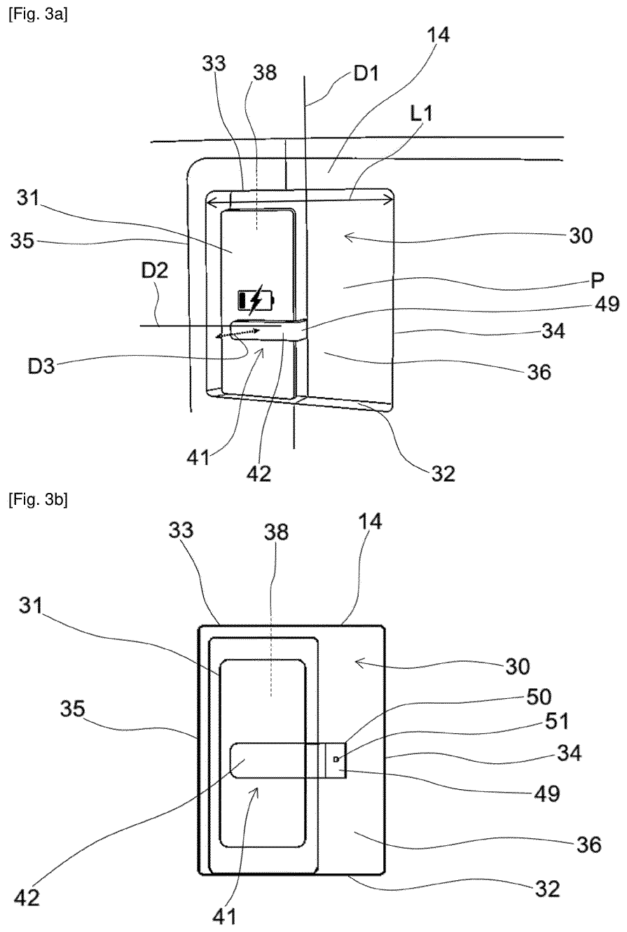

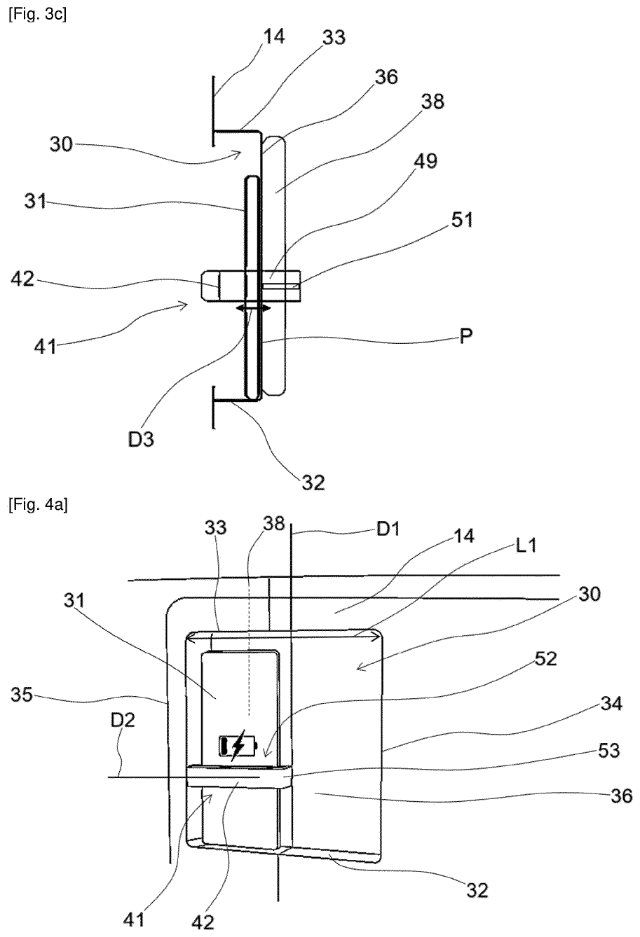

FIG. 3a FIG. 3b FIG. 3c FIGS. 3a, 3b, and 3c are respectively perspective, front, and side views of a second embodiment of a device according to the invention for retaining a portable electronic appliance inside an induction charging housing;

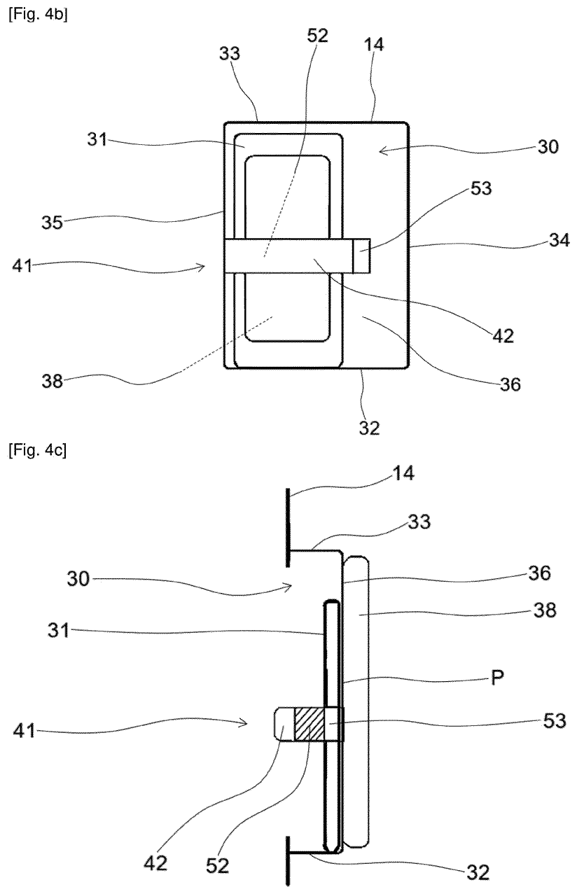

FIG. 4a FIG. 4b FIG. 4c FIGS. 4a, 4b, and 4c are respectively perspective, front, and side views of a third embodiment of a device according to the invention for retaining a portable electronic appliance inside an induction charging housing.

It should be noted that the structural and/or functional elements common to the different embodiments have the same references. Thus, unless otherwise stated, such elements have identical structural, dimensional and material properties.

Furthermore, in the remainder of the description, the relative terms of the type “lower”, “upper”, “left”, “right”, “horizontal”, “vertical” are understood by reference to the common meaning that a passenger in a seat in front of which there is an induction charging housing according to the invention would give them.

FIG. 1 shows a seat unit 10 having an seat 12 associated with a side console 13 extending along one side of the seat 12.

More specifically, the seat 12 comprises a seating pan 12.1 and a backrest 12.2. The seat 12 has an extension axis X1 defined by the intersection between a horizontal plane and a vertical median plane of the seat 12 corresponding to a plane of symmetry of the seat 12. The extension axis X1 of the seat 12 may form a non-zero angle with respect to a direction parallel to or coincident with a central axis of the aircraft X2. In this case, the seat 12 is oriented in the direction of the axis X2. Alternatively, the seat 12 may be oriented in a direction opposite to the axis X2. Alternatively, the axis X1 of the seat 12 extends parallel to the central axis of the aircraft X2.

The seat 12 is advantageously provided with a kinematics allowing it to be movable between a “seating” position, in which the seat 12 is configured to define a seating position of a passenger, and a “reclined” position, in which the seating pan 12.1 and the backrest 12.2 define a sleeping surface, advantageously substantially horizontal, for the passenger. Intermediate comfort positions are also offered, such as the “relax” position in which a backrest of the seat 12 is strongly inclined.

A privacy shell 14 extends at least partially around the seat 12 so as to delimit a space around the passenger. The privacy shell 14 is made for example from a composite material. Such a configuration allows to guarantee the privacy of the passenger in the seat 12.

A video screen 16 of a multimedia system or IFE (for “Inflight Entertainment System”) can be installed on a rear portion of the privacy shell 14 so as to be usable by a rear passenger.

The console 13 may comprise an upper wall 17 forming a table on which the passenger can place objects as well as a storage space 18 comprising one or more elements among a literature pocket, a bottle holder, or a minibar. The choice of storage equipments is configurable according to the wishes of the airline. The console 13 may also include a reading light 19 towards the seat 12.

A cavity 21 is located under the upper wall 17. The cavity 21 is laterally open towards the seat 12. In addition, a horizontal face 22 of the console 13 has in particular an armrest function. For this purpose, the horizontal face 22 may locally have a curved cuff shape 23 matching the shape of a portion of the passenger's arm.

The console 13 also includes a control unit 25 for the seat 12 and its additional components (called “PCU” for “Passenger Control Unit”). The control unit 25 allows the passenger in particular to control the selection of a position of the seat 12 as well as the additional components, such as a video system, a heating device, a lighting ambiance system or any other additional component that can be integrated into the seat 12.

In order to allow the passenger to lie down, the console 13 may include a hollow space 27 in a phantom view in FIG. 1 in which an ottoman 28 is arranged. The ottoman 28 includes a horizontal face forming a footrest on which a rear passenger can place his feet when the seat 12 is in the “lying” position.

The seat unit 10 may also conventionally comprise a meal tray 26 movable between a stored position (corresponding to that in FIG. 1) in which the meal tray 26 is located inside a housing in the console 13 and a deployed position in which the meal tray 26 is outside the housing so as to allow the passenger to place a meal tray thereon.

As can be seen in FIGS. 2a, 2b, and 2c, the seat unit 10 further comprises an induction charging housing 30 for a portable electronic appliance 31. This portable electronic appliance 31 may take the form of a mobile phone, a digital tablet, or a laptop computer. In the remainder of the description, reference is made to a mobile phone as an example, but it is clear that this mobile phone could be replaced with any other portable electronic appliance capable of being recharged by induction.

The induction charging housing 30 is located at the rear of the backrest 12.2. In this case, the induction charging housing 30 is made in the rear face of the privacy shell 14. Alternatively, the induction charging housing 30 can be made in the rear face of the backrest 12.2.

The induction charging housing 30 comprises a lower face 32 for an edge of the mobile phone 31 to bear thereon, an upper face 33, a right side face 34, a left side face 35, and a housing bottom 36. The bottom 36 is set back relative to the rear face of the privacy shell 14 or, if need be, of the backrest 12.2. The faces 32, 33, 34, 35 extend perpendicularly to the bottom 36.

The induction charging housing 30 has a vertical orientation, such that the bottom 36 of the induction charging housing 30 extends in a vertical plane P. The induction charging housing 30 is thus open to the outside in a horizontal direction. Advantageously, the induction charging housing 30 has a longitudinal elongation direction D1 extending in a vertical direction. Alternatively, the longitudinal elongation direction D1 can extend in a horizontal direction.

An induction charger 38 is capable of generating a magnetic field inside the induction charging housing 30. The action of this magnetic field causes the appearance of a charging current for a battery inside the mobile phone 31 provided with a coil for this purpose. The induction charger 38 is advantageously arranged behind the bottom 36 of the induction charging housing 30. Alternatively, the induction charger 38 constitutes at least a portion, or even the entirety, of the bottom 36. Thus, when the mobile phone 31 is pressed against the bottom 36 of the housing 30, the recharging of the battery in the mobile phone 31 can be carried out without contact via the induction charger 38.

A retaining device 41 of the portable electronic appliance 31 comprises a transverse arm 42. The retaining device 41 is configured so that the transverse arm 42 keeps the portable electronic appliance 31 pressed against the bottom 36 of the induction charging housing 30 behind which the induction charger 38 is arranged.

For this purpose, the transverse arm 42 has a longitudinal extension direction D2 extending parallel to the bottom 36 of the induction charging housing 30. Advantageously, the transverse arm 42 has a longitudinal extension direction D2 extending in a horizontal direction. In the example shown, the transverse arm 42 has a longitudinal extension direction D2 extending perpendicular to the longitudinal elongation direction D1 of the induction charging housing 30. Alternatively, the transverse arm 42 has a longitudinal extension direction extending in a vertical direction.

Advantageously, the transverse arm 42 extends along at least a portion of the induction charging housing 30 having a width L1, in particular along at least 30%, in particular at least 50% of the total width of the induction charging housing 30. Preferably, the transverse arm 42 is configured to extend along at least 80% of the width L1 of the mobile telephone 31 and preferably along the entire width of the mobile telephone 31.

The transverse arm 42 is preferably located at an intermediate height L2 of the induction charging housing 30 so as to ensure a uniform support on the portable electronic appliance 31. The intermediate height L2 is between 20% and 80%, preferably between 20% and 50%, of the total height L3 of the induction charging housing 30. The heights L2 and L3 are measured vertically relative to the lower face 32 of the induction charging housing 30.

In the embodiment of FIGS. 2a, 2b, and 2c, the retaining device 41 is rotatable about a spring hinge 44 having a horizontal axis X3.

More specifically, the retaining device 41 comprises two lateral arms 45, 46 extending on either side of the transverse arm 42. Each lateral arm 45, 46 comprises a free end connected to the spring hinge 44. The movable part thus has an inverted U shape so as to be able to support the mobile telephone 31 in its central part without hiding the lower and lateral parts of the mobile telephone 31.

The spring hinge 44 is positioned below or at the underside 32 of the induction charging housing 30. The spring hinge 44 may be located in the plane of the bottom 36 of the induction charging housing 30. Alternatively, the spring hinge 44 may be set bac relative to the plane of the bottom 36 of the induction charging housing 30.

The retaining device 41 is movable between an open position in which the retaining device 41 is spaced apart from the bottom 36 of the induction charging housing 30 so as to allow the insertion of the mobile telephone 31 into the space between the transverse arm 42 and the bottom 36 of the induction charging housing 30 and a closed position in which the retaining device 41 bears via the transverse arm 42 against the front face of the mobile telephone 31 so that said mobile telephone 31 is pressed against the bottom 36 of the induction charging housing 30.

In the open position, the gap between the retaining device 41 and the bottom 36 of the housing is of the order of 10 mm in order to facilitate the positioning of the mobile phone 31. When no mobile phone 31 is placed behind the transverse arm 42, the transverse arm 42 is pressed against the bottom 36 of the induction charging housing 30 or there is a very small gap, in particular between 1 mm and 5 mm relative to the bottom 36 of the induction charging housing 30. Such a clearance of the retaining device 41 thus permits an easy adaptation to mobile phones 31 of variable thickness from one model to another.

In order to install her/his mobile phone 31 inside the charging housing, the passenger pulls the retaining device 41 towards her/him, so as to cause it to pivot around the spring hinge 44 according to the arrow F1 in order that the transverse arm 42 moves away from the bottom 36 and thus the retaining device 41 moves into the open position. The passenger can then position her/his mobile phone 31 between the bottom 36 of the induction charging housing 30 and the transverse arm 42. By releasing the retaining device 41, the transverse arm 42 automatically presses the mobile phone 31 against the bottom 36 of the induction charging housing 30 and therefore against the induction charger 38 due to the action of the spring in the hinge 44. When the retaining device 41 is pressed against the mobile phone 31, the angle formed by the side arms 45, 46 relative to a vertical direction depends on the thickness of the mobile phone 31.

In the embodiment in FIGS. 3a, 3b, 3c, the retaining device 41 is movable in translation in a direction D3 normal to the bottom 36 of the induction charging housing 30.

The retaining device 41 comprises the transverse arm 42 and a guiding arm 49 capable of sliding inside a guiding cavity 50 in the bottom 36 of the induction charging housing 30. The guiding arm 49 may be located on the side of the right lateral face 34 or the left lateral face 35 of the induction charging housing 30. The retaining device 41 is thus L-shaped. The space delimited by the retaining device 41 and the bottom 36 of the housing is open on the side opposite the guiding arm 49.

A return spring 51 is disposed inside the guiding cavity 50. The return spring 51 tends to apply a return force to the retaining device 41 towards the bottom 36 of the induction charging housing 30.

The retaining device 41 is movable between an open position in which the retaining device 41 is spaced apart from the bottom 36 of the induction charging housing 30 so as to allow the insertion of the mobile telephone 31 into the space between the transverse arm 42 and the bottom 36 of the induction charging housing 30 and a closed position in which the retaining device 41 comes to bear via the transverse arm 42 against the front face of the mobile telephone 31 so as to cause said mobile telephone 31 to press against the bottom 36 of the induction charging housing 30.

In the open position, the gap between the retaining device 41 and the bottom 36 of the housing is of the order of 10 mm in order to facilitate the positioning of the mobile telephone 31. When no telephone is placed behind the transverse arm 42, the transverse arm 42 is pressed against the bottom 36 of the induction charging housing 30 or there is a very small gap, in particular between 1 and 5 mm relative to the bottom 36 of the induction charging housing 30. Such a clearance of the retaining device 41 thus makes it possible an easy adaptation to mobile phones of varying thickness from one model to another.

In order to install her/his mobile phone 31 inside the induction charging housing 30, the passenger pulls the retaining device 41 towards her/him so as to move the transverse arm 42 away from the bottom 36 in order that the retaining device 41 moves into an open position. The passenger can then position her/his phone between the bottom 36 and the transverse arm 42. By releasing the retaining device 41, the transverse arm 42 automatically presses the phone against the bottom 36 of the induction charging housing 30 and therefore against the induction charger 38 due to the action of the return spring 51.

In the embodiment in FIGS. 4a, 4b, and 4c, the retaining device 41, in particular the arm 42, is fixed relative to the induction charging housing 30. A layer 52 of deformable material is fixed to a rear face of said transverse arm 42 opposite the bottom 36 of the induction charging housing 30. The fixation of the layer 52 of deformable material can be carried out by gluing, overmolding, or any other fixing technique suitable for the application. The layer 52 of deformable material is preferably formed by a shape-memory foam layer. Alternatively, it is possible to use any other deformable material suitable for the application.

The layer 52 of deformable material being intended to be compressed so as to keep the mobile phone 31 pressed against the bottom 36 of the induction charging housing 30.

The transverse arm 42 may be connected to the bottom 36 of the induction charging housing 30 via a connecting arm 53 at one end of the transverse arm 42. The connecting arm 53 may be located on the right lateral face 34 or the left lateral face 35 side of the induction charging housing 30. The free end of the transverse arm 42 may be mechanically connected to the lateral face opposite that on which the connecting arm 53 is arranged. Alternatively, the transverse arm 42 may be connected directly to the right lateral face 34 or left lateral face 35 of the induction charging housing 30. The transverse arm 42 then extends from the left or right transverse face transversely inside the induction charging housing 30. Alternatively, connecting arms 53 arranged on either side of the transverse arm 42 are mechanically connected to the bottom 36 of the induction charging housing 30.

In the absence of a phone, the foam layer 52 is not crushed, that is to say compressed. There is then a small space,

For example between 3 mm and 7 mm and preferably of 5 mm between the bottom 36 of the storage equipment and the foam layer 52. This gap is intended to be less than a thickness of the mobile phone 31.

When the mobile phone 31 is inserted behind the transverse arm 42 between the foam layer 52 and the bottom 36 of the induction charging housing 30, the foam layer 52 becomes compressed between the mobile phone 31 and the fixed arm 42 so that the mobile phone 31 is held in position inside the induction charging housing 30. When the foam layer 52 is compressed, the space between the foam and the bottom 36 of the induction charging housing 30 corresponds to the thickness of the phone. The space is for example between 8 mm and 10 mm. The compression of the foam layer 52 generated by the placement of the mobile phone 31 makes it possible to ensure that the mobile phone 31 is pressed against the induction charger 38 while avoiding lateral movements of the mobile phone 31.

Of course, the different characteristics, variants and/or embodiments of the present invention can be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A seat unit for a transport vehicle comprising a seat comprising a seating pan and a backrest,
an induction charging housing for a portable electronic appliance,
said induction charging housing has a vertical orientation,
said induction charging housing comprising a lower face for an edge of the portable electronic appliance to bear thereon, an upper face a right side face a left side face and a housing bottom,
an induction charger capable of generating a magnetic field inside the induction charging housing, and
a retaining device for the portable electronic appliance comprising a transverse arm located at an intermediate height of the induction charging housing,
said retaining device being configured so that the transverse arm keeps the portable electronic appliance pressed against the bottom of the induction charging housing,
wherein the retaining device is movable in translation in a direction normal to the bottom of the induction charging housing,
the retaining device comprising the transverse arm and a guiding arm capable of sliding inside a guiding cavity in the bottom of the induction charging housing.

2.-3. (canceled)

4. The seat unit according to claim 1, wherein a return spring is arranged inside the guiding cavity.
